(19) United States
(12) Patent Application Publication
(10) Pub. No.: US 2008/0136623 A1
(43) Pub. Date: Jun. 12, 2008

(54) AUDIO TRIGGER FOR MOBILE DEVICES

(76) Inventor: Russell CALVARESE, Stony Brook, NY (US)

Correspondence Address: FAY KAPLUN & MARCIN, LLP, 150 BROADWAY, SUITE 702, NEW YORK, NY, 10038, US

(21) Appl. No.: 11/567,484

(22) Filed: Dec. 6, 2006

(51) Int. Cl. H04Q 7/00; H04Q 5/22; H04R 3/00

(52) U.S. Cl. 340/539.11; 340/10.3; 381/122

(57) ABSTRACT

A mobile computing device having a reader element collecting information from target items, an audio system triggering a read event when a trigger sound is discerned and a processor activating the reader element when the read event is triggered by the audio system. The mobile computing device may be used to monitor with an audio system to detect a trigger sound, trigger a read event upon detection of the trigger sound and activate a reader element to acquire data pertaining to a tracked item.

### BACKGROUND

Supply chains for manufacturers, retailers and other businesses are very dependent on the ability to know at any time the location of supplies, products, goods etc. To accomplish this, various technologies have been developed to identify items being transported and record the item's location, status and other pertinent data. Bar codes, RFID tags and other means of identification and tracking are routinely placed on the items, and corresponding sensors are used to track them.

It may be useful to track items as they pass though known points of a transportation chain. For example, when items such as boxes are loaded or unloaded from a truck or other transport. This can be a very fast paced environment, where workers are busy moving items that may be heavy and bulky, and may not be in a position to operate the tracking devices.

### SUMMARY OF THE INVENTION

A mobile computing device having a reader element collecting information from target items, an audio system triggering a read event when a trigger sound is discerned and a processor activating the reader element when the read event is triggered by the audio system.

A method of tracking items by monitoring with an audio system to detect a trigger sound, triggering a read event upon detection of the trigger sound and activating a reader element to acquire data pertaining to a tracked item.

A wearable RFID tracking device having an RFID reader for interrogating an RFID tag of a tracked item and receiving data therefrom and an audio system for detecting background sounds and a trigger sound, the audio system triggering a read event of the RFID reader when the trigger sound is discerned from the background sounds.

### BRIEF DESCRIPTION OF DRAWINGS

FIG. 1 is a diagram showing an embodiment of an audio triggered scanning device according to the invention.

FIG. 2 is a flowchart depicting steps in the operation of an audio trigger tracking device according to an embodiment of the present invention.

### DETAILED DESCRIPTION

The present invention may be further understood with reference to the following description and to the appended drawings, wherein like elements are referred to with the same reference numerals. The invention relates to an audio trigger used to operate a tracking device when a selected sound is sensed. In one exemplary embodiment, the audio trigger may operate an RFID reader when a box or similar item is picked up for loading/unloading from a transport.

Inventory control and other processes are based on being able to track the location and status of various items within a supply or production chain. For example, a retailer may want to know what items are located in a certain store at a given time. A manufacturer may want to know what raw materials arrive at a plant, and what products are shipping. In these and many other situations it is necessary to identify the items of interest and track their location and status.

Various technologies are available for tracking. For example, bar codes may be affixed on the items and may be read by a laser or image scanner. More recently, radio frequency identification (RFID) tags have been embedded in items so that an RFID reader may be used to track the items. The item's identity as well as other pertinent data may be encoded in the RFID tag, which either broadcasts a low power transmission containing the data (active RFID tag) or transmits the data via backscatter when interrogated by the RFID reader (passive RFID tag).

One may be interested in tracking items such as every box that is loaded or unloaded from a truck, pallet, railroad car or other transport. Workers moving the items may be tasked to operate a scanner or a reader to track the items while moving the items. This may be difficult if the items are heavy or bulky, or if the working environment makes it difficult to handle the scanning equipment. Typically the worker has to stop moving boxes then pick up, use and replace the scanner. These tasks use up additional time, and may promote damage to the equipment.

To simplify the task of those workers moving and tracking the items, miniaturized tracking devices may be worn as a ring, bracelet, strapped to the back of the worker's hand or worn on other parts of the body. These wearable devices, however, still have to be activated by the user and often have to be positioned correctly so that they are able to scan the item and obtain the data.

The present invention provides embodiments of an audio trigger that may be used to activate portable devices, in particular wearable tracking devices, in response to a trigger sound. The exemplary embodiments of the invention provide an improved ergonomic environment for the workers, and substantially reduce the additional time necessary to track the items of interest. The exemplary embodiments also free the users' hands and fingers to accomplish the task at hand (e.g., picking up a box), rather than needing the hand or fingers to trigger or activate the portable device. The workers therefore become more efficient in simultaneously moving and tracking the items.

In one exemplary embodiment, the triggering of the tracking device is accomplished automatically without user intervention. The exemplary automatic trigger comprises an audio system and a microphone fitted to a hand worn tracking device. The microphone senses the surrounding ambient sounds as well as a trigger sound such as the sound of the worker's hand hitting the box when picking it up to move it. The trigger sound is used to start the scanning process, which identifies the box and stores or sends data associated with the box, such as time, location, box identification etc. As can be seen from this exemplary embodiment, the automatic trigger allows the worker to continue to perform his/her normal task (e.g., picking up the box) without adding an extra step of having to trigger the device. This saves time for the workers as they do not have to take the time for a separate action to trigger the device. In addition, it alleviates the need for the worker to remember to trigger the device, as the automatic trigger performs the triggering action while the worker continues about their normal duties.

In the exemplary embodiment, the tracking method uses RFID tags placed in or attached to the boxes that are interrogated by an RFID reader to acquire the data stored therein. However, those skilled in the art will understand that the tracking device may be any type of portable device that may be used to track items of interest. For example, the portable device may be a bar code scanner that is triggered to read a bar code that is printed or affixed to an item. The portable device may be a mobile computing device that includes either an integral or peripheral imaging device (e.g., a camera) for collecting images when triggered for the purposes of tracking items of interest. Thus, while the exemplary embodiments are described with reference to RFID tags and RFID readers, the applicability of the audio trigger described herein is broader in scope to include any type of mobile device and any type of functionality provided by the mobile devices that would benefit from intermittent activation based on audio input.

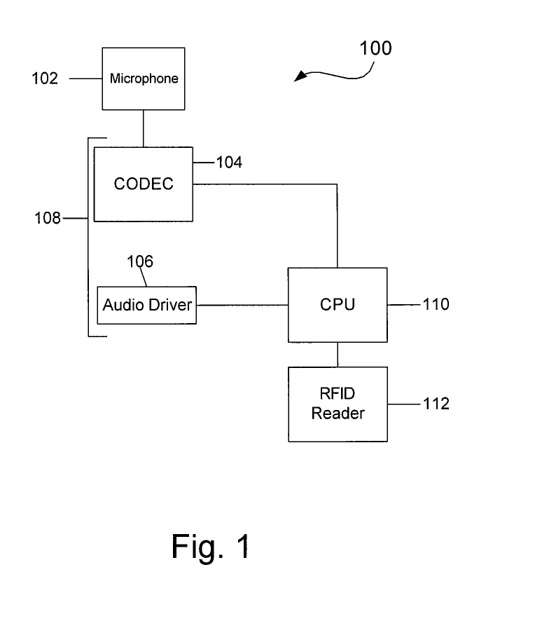

FIG. 1 shows some of the components forming an exemplary embodiment of an audio activated tracking device according to the present invention. As described above, in this exemplary embodiment, the mobile device including the audio triggered device 100 is a wearable mobile device that includes an RFID reader 112. The audio triggered device 100 may be worn, for example, attached to one or more of the user's fingers or on the back of the user's hand. The mobile device (or other components) may be in the same location or may be attached to the user at a different location (e.g., strapped to the user's arm) and may be electrically connected to the audio triggered device 100.

The audio triggered device 100 comprises a microphone 102 and an audio system 108 having a CODEC element 104 and an audio driver 106. The microphone 102 and audio system 108 may be specifically provided to perform the triggering function, or may be used for some other purpose to which the triggering function is added. For example, the hand worn device may include a communication function allowing the user to transmit and receive voice communications.

The CODEC element 104 of the audio system is a hardware element that translates the analog signal from the microphone 102 to a digital signal to be used by the CPU 110. The CPU 110 may control the overall function of the hand worn device, or may be used exclusively to control the triggering function. The CPU 110 may be any processor used to operate handheld devices. Those skilled in the art will also understand that the CODEC element 104 and audio driver 106 may be replaced by functionality in the CPU 110. For example, if the CPU 110 had an analog input, the CODEC element 104 would not be needed.

The exemplary audio driver 106 comprises software used to interact with the CODEC element 104. According to the exemplary embodiments of the present invention, the audio driver 106 may include instructions to scan the data from the CODEC element 104 and to detect the trigger sound made by the hand of the worker hitting the box, as it is picked up to be moved. In the exemplary embodiment, the microphone 102 is placed very near the source of the trigger sound, since it is worn on the hand used to pick up the box. As a result, the ambient sounds sensed by the microphone 102 have a much smaller amplitude than the high amplitude trigger sound. The exemplary system thus can easily detect the trigger sound when the worker picks up the box, and can trigger a read event by the RFID reader 112 at the optimal time, e.g., when the distance to the box is sufficiently small. For example, the audio driver 106 may be designed to trigger the RFID read event as soon as the trigger sound is sensed.

Those skilled in the art will understand that different mechanisms to detect the trigger sound may be used, which may utilize devices other than a CPU, a CODEC or a driver. That is, other software and/or hardware may be used to discriminate a triggering sound. In the exemplary embodiment, the amplitude of the sound signal was used. In other exemplary embodiments, it may be possible to use frequency sampling to determine a specific triggering sound or a sequence of sounds that indicate a trigger sound has occurred. In another exemplary embodiment, it may be possible to compare an analog waveform received by the audio triggered device 100 to a stored waveform to determine if a trigger sound has occurred. Those skilled in the art will understand that there are other types of mechanisms that may be used to detect a trigger sound.

Triggering the read signal such as the RFID read event at the optimum time provides several advantages. For example, the power consumption of the device is reduced because the RFID reader 112 will be triggered at the ideal time, thereby reducing the transmit time when not in range of an RFID tag. The transmission to interrogate the RFID tag only needs to occur for a short time, when the box is nearest to the tracker. The battery life of the device is accordingly increased. In addition, as described above, the triggering of the device occurs while the worker is performing their normal duties without requiring a separate action to trigger the device. This saves both time and effort being expended by the worker on a task (triggering) that is performed automatically.

Using a low power transmission to interrogate the tracked item's tag when it is nearest to the RFID reader 112 may also reduce the erroneous reading of adjacent tags. By delaying the triggering of the RFID read event until the target box is in close range, as when the worker picks up the box, there is a reduced probability that other nearby boxes will be mistakenly tracked by the RFID reader 112 worn on the worker's hand.

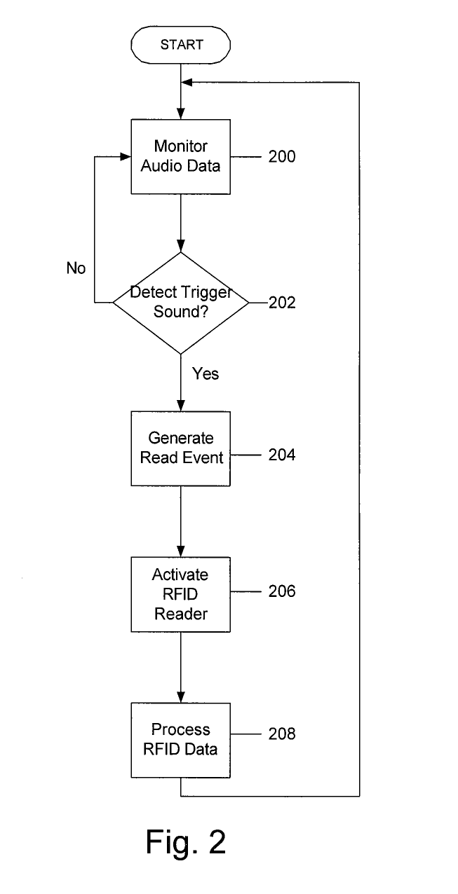

FIG. 2 shows a flow diagram describing the operation of an exemplary embodiment of the audio trigger device 100 according to the present invention. In step 200, the sounds in the environment of the audio trigger device 100 are detected by the microphone 102 and translated via the CODEC 104 to create a data stream. The driver 106 monitors the data stream to determine if a trigger sound is received (step 202). As described above, in this example, the determination of the trigger sound is based on the amplitude of the received sounds. Thus, if the driver 106 determines that the amplitude of a received sound is above a predetermined threshold, the driver 106 determines that a trigger sound has been received by the audio trigger device 100. As long as the trigger sound is not detected, step 202 continues to loop causing the monitoring of the data stream to continue until a trigger sound is detected.

When a trigger sound is detected in step 202, the audio driver 106 triggers an RFID read event in step 204. This results in activation of the RFID reader 112 in step 206. The RFID reader 112 emits the interrogation radio transmission and receives the reply from the RFID tag in the targeted box containing, for example, identification data. Additional processing of the identification data may take place in step 208. For example, the identification received form the RFID tag may be stored in the device, or may be transmitted to a remote device. Additional information such as location, time, status of the box, or any other information desired by the user may be included to generate an output of the device. The method may then continue to detect other instances of the desired trigger sound.

Although the preceding description referred to audio triggering of RFID devices, those of skill in the art will understand that other tracking technologies may be used according to the invention. For example, a laser scanner system may be used to read bar code tags affixed to the items to be tracked. Alternatively, other tracking technologies may also be used in conjunction with the audio trigger system according to the invention.

It should also be noted that the audio triggering system of the present invention may be implemented in conjunction with a mechanical triggering device (e.g., a hand or finger operated switch). Thus, a user may have the option of manually activating the RFID (or other type of) reader. In such a situation, the reader may be programmed to operate at different power levels based on the type of activation, e.g., a higher power level for manual activation and a lower power level for sound activation.

The present invention has been described with reference to specific exemplary embodiments. Those skilled in the art will understand that changes may be made in details, particularly in matters of shape, size, material and arrangement of parts. Accordingly, various modifications and changes may be made to the embodiments. The specifications and drawings are, therefore, to be regarded in an illustrative rather than a restrictive sense.

What is claimed is:

1. A mobile computing device, comprising:
a reader element collecting information from target items;
an audio system triggering a read event when a trigger sound is discerned; and
a processor activating the reader element when the read event is triggered by the audio system.

2. The device according to claim 1, wherein the audio system includes a microphone.

3. The device according to claim 1, wherein the audio system includes an audio driver for scanning data from a CODEC of the audio system to discern the trigger sound and trigger the read event.

4. The device according to claim 1, wherein the reader element comprises one of an RFID reader, a laser scanner and an imager.

5. The device according to claim 1, wherein the processor further processes the information collected from the target items.

6. The device according to claim 1, wherein the audio system discerns the trigger sound based on at least one of an amplitude of the trigger sound, a frequency of the trigger sound and a waveform of the trigger sound.

7. The device according to claim 1, wherein the processor activates the reader element for a predetermined period of time upon receiving the read event.

8. The device according to claim 1, wherein at least a portion of the device is wearable.

9. A wearable RFID tracking device, comprising:
an RFID reader for interrogating an RFID tag of a tracked item and receiving data therefrom; and
an audio system for detecting background sounds and a trigger sound, the audio system triggering a read event of the RFID reader when the trigger sound is discerned from the background sounds.

10. The RFID tracking device according to claim 9, further comprising:
a processor controlling the RFID reader and the audio system, the processor manipulating the data received by the RFID reader.

11. The RFID tracking device according to claim 10, wherein the processor combines the data from the RFID tag with at least one of date, time, location and status information.

12. The RFID tracking device according to claim 9, wherein the audio system includes an audio driver screening a data stream of an audio CODEC to discern the trigger sound from the background sounds.

13. The RFID tracking device according to claim 12, wherein the audio driver discerns a higher amplitude of the trigger sound compared to a lower amplitude of the background sounds.

14. The RFID tracking device according to claim 9, wherein the audio system is wearable on a user's hand.

15. The RFID tracking device according to claim 9, wherein the RFID reader interrogates the RFID tag with a reduced power signal when activated by the audio system.

16. The RFID tracking device according to claim 9, wherein the audio system detects the trigger sound corresponding to a user picking up the tracked item.

17. A method of tracking items, comprising:
monitoring with an audio system to detect a trigger sound;
triggering a read event upon detection of the trigger sound; and
activating a reader element to acquire data pertaining to a tracked item.

18. The method according to claim 17, further comprising:
manipulating the data pertaining to the tracked item in a processor.

19. The method according to claim 17, wherein the reader element is one of an RFID reader, a laser scanner and an imager.

20. The method according to claim 18, wherein the manipulating includes combining the data with at least one of a time, a date, a location and status information.

21. A mobile device, comprising:
a reader means for collecting information from target items;
an audio means for triggering a read event when a trigger sound is discerned; and
a processing means for activating the reader element when the read event is triggered by the audio means.
